(19) United States
(12) Patent Application Publication
(10) Pub. No.: US 2008/0119764 A1
(43) Pub. Date: May 22, 2008

(54) Muscular relief apparatus

(75) Inventors: Jung Ki Song, Gyeonggi-do (KR); Ki Young Eom, Gyeonggi-do (KR); Gong Sun Hong, Gyeonggi-do (KR)

Correspondence Address: BACON & THOMAS, PLLC, 625 SLATERS LANE, FOURTH FLOOR, ALEXANDRIA, VA, 22314, US

(73) Assignees: Jung Ki Sung, Gyeonggi-do (KR); Ki Young Eom, Gyeonggi-do (KR); Shiztec Co., Ltd., Gyeonggi-do (KR)

(21) Appl. No.: 11/819,539

(22) Filed: Jun. 28, 2007

(30) Foreign Application Priority Data
Nov. 17, 2006 (KR) 10-2006-0113953

(51) Int. Cl. A61H 1/00

(52) U.S. Cl. 601/23; 601/46

(57) ABSTRACT

A muscular relief apparatus capable of relaxing muscle of a body part includes a case having a space formed therein and a gripping-part that is gripped by a hand; a muscular relief member in contact with the body part and making a vibration by a reciprocal movement; a motor installed in the space of the case for generating rotational force; and a transmission module for converting the rotational force into the reciprocal movement of the muscular relief member. The apparatus further includes a guide rail provided in the case; a moving member connected by the transmission module to apply a linear reciprocal movement along the guide rail; and a plurality of supporting parts installed on the bottom surface of the moving member to support the muscular relief member.

### FIELD OF THE INVENTION

The present invention relates to a hand-type muscular relief apparatus; and, more particularly, to a hand-type muscular relief apparatus that is capable of carrying out exercise partially for a body part by a vibration made of reciprocal movement while a user grasps the apparatus.

### BACKGROUND OF THE INVENTION

The moderns always keep a state of having their muscle sustained in their daily lives where they are always busy and strained, and this might cause a pain in a body part or might cause a complication. Accordingly, the muscle sustained like this needs to be relaxed at all times. Methods for relaxing the muscle might include physical exercise, massage and the like. Such methods have effects such as blood circulation promotion, muscle adhesion prevention and the like, and might prevent obesity due to the burning of adipose by giving stimuli to adipose tissue, maintain body in balance, and preserve facial contour and skin.

In recent years, exercise equipment, massage machine and the like, which can relax the muscle occasionally, have been widely used. In general, a conventional massage machine is reciprocally driven over a target body part in use of a driver such as solenoid, motor or the like to perform a pounding massage on a target person.

However, the reciprocally driven pounding massage above has a problem in that, as the massage is limited to pounding, the effect of the massage is not great.

Further, a plurality of exercise machines effective in fat burning have been selling. However, such machines are also mainly configured in that the user directly applies force to do exercise. Thus, the exercise machine is not suitable for those who need to have a rehabilitation treatment or senior citizens who should not exercise intensively. In addition, there is a disadvantage in that such exercise machines are not easy to be applied partially to the forearm, the inner part of a thigh and the like where removing the body fat is difficult.

### SUMMARY OF THE INVENTION

It is, therefore, a primary object of the present invention to provide a compact hand-type muscular relief apparatus that has a compact size capable of being grasped by a user and that can be easily used while being in contact with body parts such as forearm, neck and vicinity, the inner part of a thigh, etc.

It is another object of the present invention to provide a hand-type muscular relief apparatus installed thereto having a additional fixing-member to fix it to a specific body part.

In accordance with the present invention, there is provided a muscular relief apparatus capable of relaxing muscle of a body part, the apparatus including: a case having a space formed therein and a gripping-part that is to be gripped by fingers of a user; a muscular relief member to be in contact with the body part for making a vibration by a reciprocal movement; a motor installed in the space of the case for generating rotational force; and a transmission module for converting the rotational force into the reciprocal movement of the muscular relief member.

### BRIEF DESCRIPTION OF THE DRAWINGS

The above and other objects and features of the present invention will become apparent from the following description of embodiments, given in conjunction with the accompanying drawings, in which:

FIG. 1 is a perspective plan view of a hand-type muscular relief apparatus in accordance with the present invention;

FIG. 2 is a front view of the hand-type muscular relief apparatus in accordance with the present invention;

FIG. 3 is a view illustrating a bottom of the hand-type muscular relief apparatus in accordance with the present invention;

FIG. 4 is a plan view illustrating an internal configuration of the hand-type muscular relief apparatus in accordance with the present invention;

FIG. 5 is a side sectional view of the hand-type muscular relief apparatus in accordance with the present invention;

FIG. 6 shows a usage of the hand-type muscular relief apparatus in accordance with the present invention; and

FIG. 7 shows a usage of the hand-type muscular relief apparatus in accordance with the present invention, to which a user attaches onto his body part by using a belt.

### DETAILED DESCRIPTION OF THE EMBODIMENTS

Embodiments of the present invention will be described in detail with reference to the accompanying drawings.

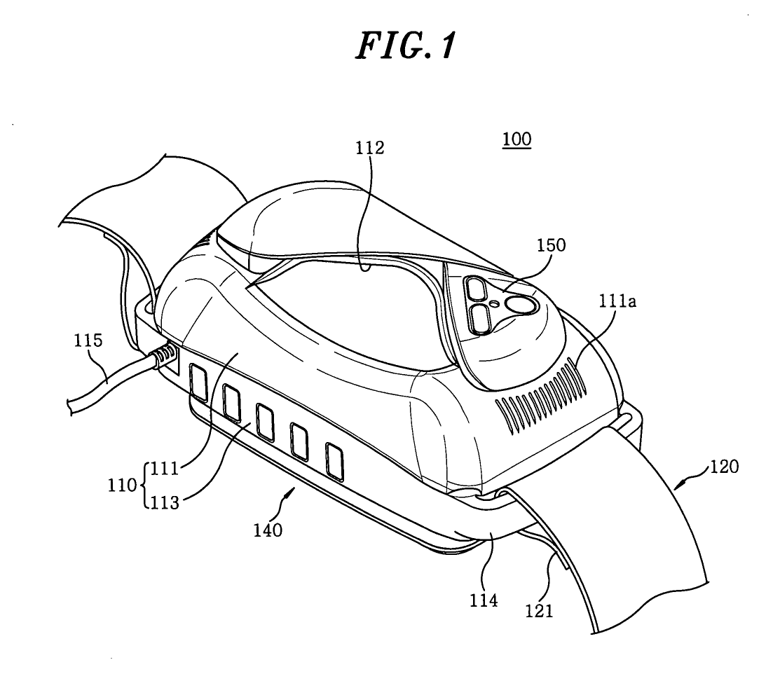

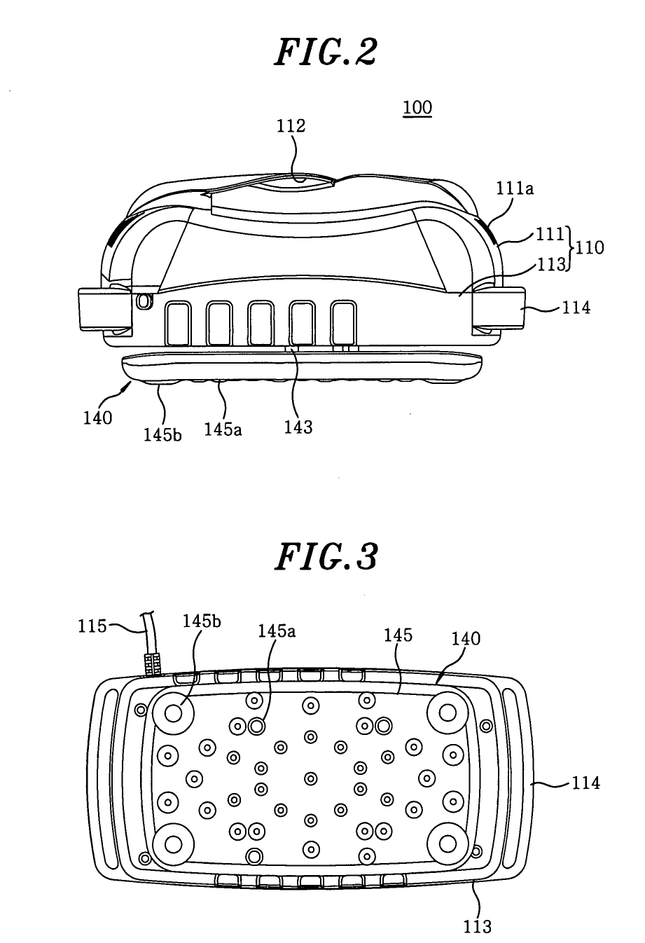

FIG. 1 is a perspective plan view of a hand-type muscular relief apparatus in accordance with the present invention, and FIG. 2 illustrates a front view of the hand-type muscular relief apparatus in accordance with the present invention.

As shown in FIGS. 1 and 2, a hand-type muscular relief apparatus 100 includes a case 110 in which a driving force generating mechanism is embedded; and a muscular relief member 140 connected to a plurality of support parts 143 of the case 110.

The muscular relief member 140 is used in contact with a body part, e.g. the neck, the inner part of the thigh, the forearm and the like. Further, a driving force of a linear reciprocal movement, generated from the inside of case 110, is transferred to the muscular relief member 140, thereby allowing the muscular relief member 140 to perform a function of inducing vibration in the body part. Further, the muscular relief member 140 is desired to be made relatively flatter and to be made smaller than the bottom surface area of a lower case 113. However, the size thereof may be large enough to transmit a sufficient vibration movement to the body part.

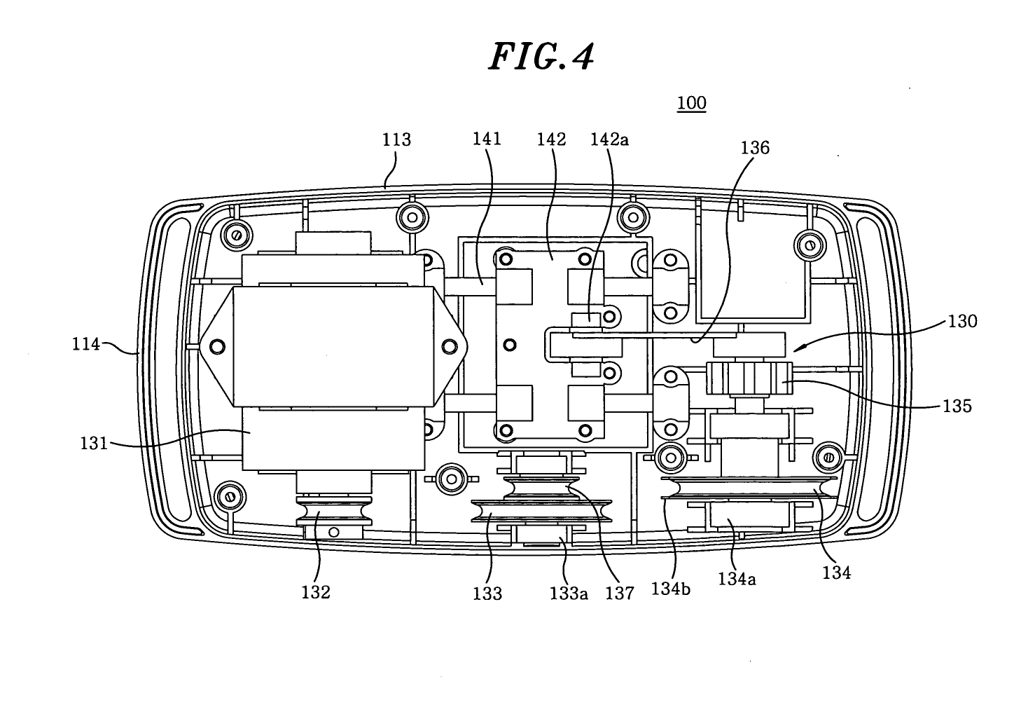

Further, as shown in FIG. 3, the muscular relief member 140 has an acupressure plate 145 attached on its bottom surface, which includes a plurality of acupressure protrusions 145a and 145b made from a silicon material. On the acupressure plate 145, the acupressure protrusions 145a are distributed over the whole surface of the muscular relief member 140, but a circular acupressure protrusion 145b larger than the acupressure protrusion 145a is formed to be projected in each corner of the muscular relief member 140. Thus, the muscular relief member 140 remains in contact with the body part in the manner of encompassing the body part, thereby enhancing the vibration effect.

The case 110 has a size suitable for a user to easily grab and carry the case 110. For example, the case 110 includes an upper case 111 and a lower case 113 made from a resin material, thereby forming a space therewithin when coupled to each other.

Formed in an upper surface of the upper case 111 is a gripping-part 112 where one side thereof is opened in a V-shape and fingers of the user can be inserted into the opened part thereof to grip the gripping-part 112. Further, installed in the upper surface of the upper case 111 is a manipulation panel 150 which is electrically connected to a driving motor 131, which is to be described later, for a driving control. The manipulation panel 150 may desirably include a on/off power button (not shown), a speed control button, a mode change button and the like. Further, the case 110 may be configured to include a detachable wireless receiver so that the muscular relief apparatus can be manipulated via radio.

Further, further formed on the upper case 111 is a ventilation hole 111a cut in a shape of a plurality of slits for dissipating the heat generated in the inside of the case 110, and the ventilation hole 111a is preferably formed in both end parts of the upper case 111.

In addition, the lower case 113 is made from the same material as the upper case 111 and combined with the upper case 111 to form the space therewithin together with the upper case 111. Ring shaped coupling loops 114 are formed in the both end parts of the lower case 113. Coupled with the coupling loops is a fixing-member 120, e.g., a belt, for fixing the muscular relief apparatus 100 to the body. It is desirable that the fixing-member 120 be long enough in length so as to allow the body to be wrapped therearound and the length to be adjusted. Further, the fixing member 120 includes a fixing-element (121), e.g., hook and loop fasteners of a Velcro (registered trademark) type, which fixes one side thereof to the coupling loops 114 by being wound around the one side thereof.

A power line 115 which supplies power to the muscular relief apparatus of the present invention is connected to and installed in the lower case 113. The power line 115 is desirable to have a length sufficient enough for the muscular relief apparatus 100 to reach any body parts.

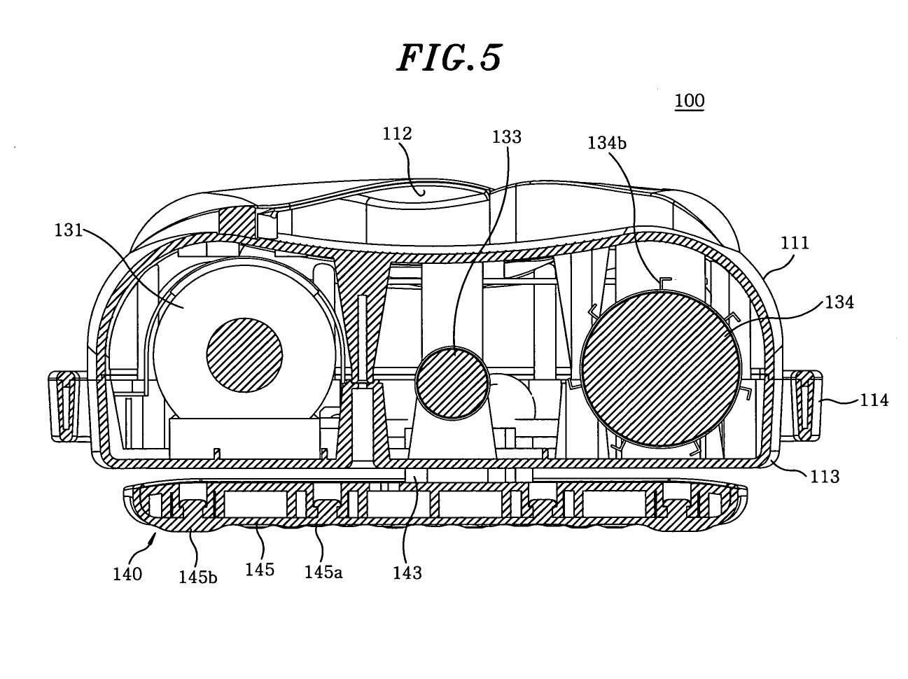

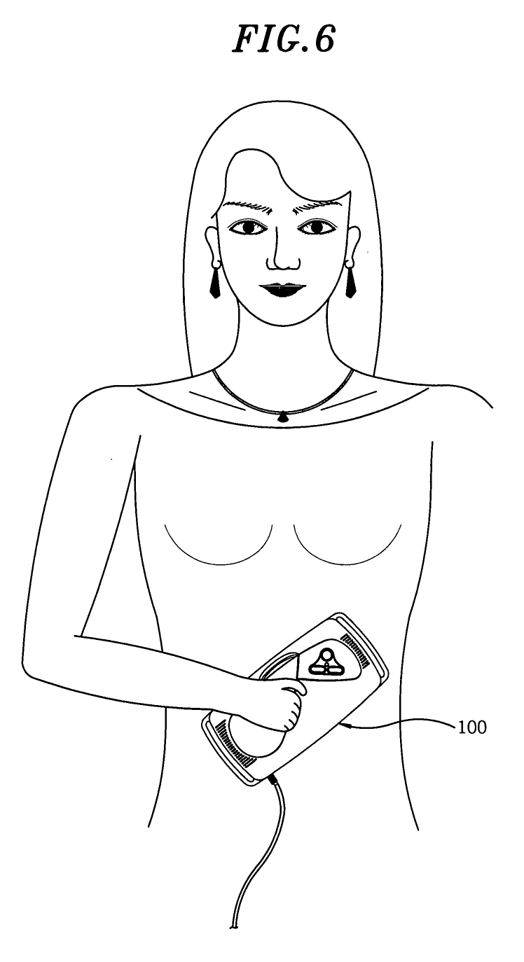

FIG. 4 is a plan view illustrating an internal configuration of a case of the hand-type muscular relief apparatus in accordance with the present invention, and FIG. 5 is a side section of the hand-type muscular relief apparatus in accordance with the present invention.

Disposed inside the upper and lower cases 111 and 113 are a driving motor 131 controlled by the manipulation panel 150 in one side; a transmission module 130 which converts the rotational force generated from the driving motor 131 into a linear reciprocal movement; and a moving member 142 which transmits the linear reciprocal movement to the muscular relief member 140.

A driving pulley 132 is connected to and installed in one end of the driving motor 131. A first reduction pulley 133 rotatably supported by a bearing 133a is connected to the driving pulley 132 through a belt (not shown), and a rotation pulley 134 rotatably supported by a bearing 134a is connected to a second reduction pulley 137 through a belt (not shown) in the same manner. In FIG. 4, both the first and second reduction pulleys 133 and 137 are illustrated as being employed in the muscular relief apparatus However, this is only for making the muscular relief apparatus small-sized, thus it is noted that any one of the reduction pulleys can be used.

Further, a fan 134b is installed along a circumference direction in one side of the rotation pulley 134 to dissipate the heat generated from the inside of the case to the outside of the case 111 through the ventilation hole 111a.

Moreover, a cam shaft 135 having an eccentric cam is installed in one end of the rotation pulley 134, and connected to the cam is one end of a connecting rod 136 which converts the rotational movement into the linear movement.

The reduction pulleys 133 and 137, the rotation pulley 134, the cam shaft 135 having the cam, and the connecting rod 136 act as the transmission module 130 to receive the rotational force of the driving motor 131 thereby moving for making the muscular relief member 140 reciprocally.

Further, a pair of guide rails 141 is horizontally installed with same interval therebetween in a central area of the inner bottom surface of the lower case 113.

The moving member 142 is installed to be moved linearly along the guide rail 141 by the transmission module 130. The moving member 142 may be configured to be in a plate shape, and connected to another end of the connecting rod 136 of which one end is connected to the cam of the cam shaft 135, as described above, and which is rotatably supported by the bearing 142a to receive the driving force and to apply the linear reciprocal movement along the guide rail 141.

Moreover, a plurality of supporting parts 143 (refer to FIG. 2) are connected from the bottom surface of the moving member 142, and are extended projecting to the outside of the lower case 113 through a guide slot (not shown). And, the supporting parts 143 is connected to the muscular relief member 140 being in contact with the body part to support the muscular relief member 140.

In accordance with the muscular relief apparatus 100 of this embodiment configured as above, the rotational force of the driving motor 131 is transmitted to the moving member 142 through the reduction pulley part 133 and 137, the rotation pulley 134, the cam and the connecting rod 136 which function as the transmission module 130. And, the moving member 142 reciprocally moves along the guide rail 141, whereby the muscular relief member 140 reciprocally moves together with the moving member 142 accordingly.

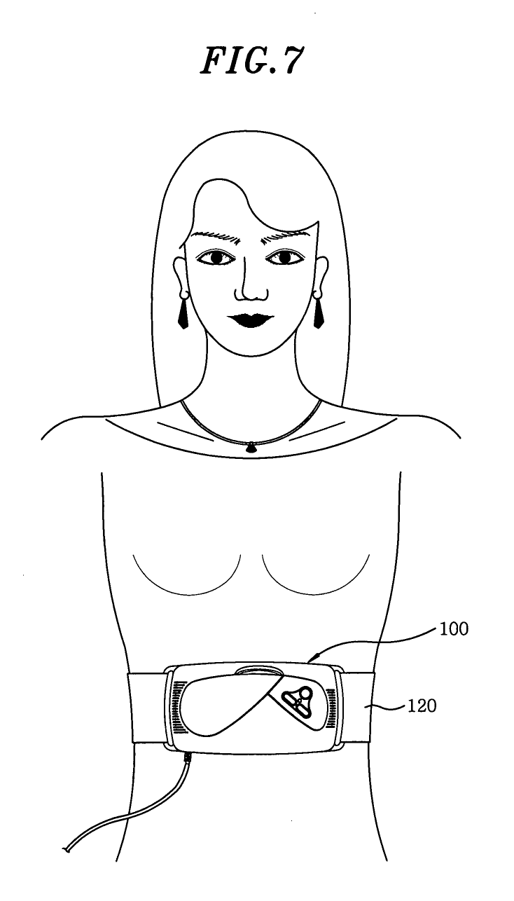

Hereinafter, an operation state of the hand-type muscular relief apparatus configured in the above in accordance with the embodiment will be explained as follows, with reference to FIG. 6.

As shown in FIG. 6, the power line is plugged in and connected to a power supply (not shown), and the user puts his fingers into the gripping-part 112 formed in the upper case 111 to grip the case 110. Thereafter, a power button in the manipulation panel 150 is pressed to apply power. At this moment, the speed control or conversion to other modes can be made by the button(s) of the manipulation panel 150.

The driving motor 131 starts to operate as power is applied thereto, and the driving force of which the torque is increased while reducing speed by the driving pulley 132 and the first reduction pulley 133, connected through the belt, is transmitted to the rotation pulley 134. Further, the driving force of which the torque is increased again by reducing speed with the reduction pulley 137 and the rotation pulley 134 is transmitted through the cam shaft 135 and the connecting rod 136, thereby allowing the moving member 142 to apply a linear reciprocal movement along the guide rail 141.

The moving member 142 applying the linear reciprocal movement along the guide rail 141 jointly moves the muscular relief member 140 connected to the supporting member 143. Therefore, it is made possible for the user to contact the muscular relief member 140 with the specific body part body which needs the muscular relief, thereby inducing a vibration thereto.

Being induced to the vibration, the stressed and sustained muscle of the contacted body part gets naturally relaxed. In particular, since the vibration vibrates the muscle left and right, thus preventing a distortion of muscle, it is effective when compared to the pounding made by the similar equipment of the prior art in that regard.

Further, the acupressure protrusions 145a and 145b of the acupressure plate 145 enhances the muscular relief effect.

Moreover, if the treatment on a specific body part is completed, it is possible to relieve muscle of any other body part such as the forearm, the inner part of the thigh or the like by easily contacting the muscular relief apparatus 100 with a body part which is difficult to be treated, after grabbing the muscular relief apparatus 100 again with a comfortable hand of the user.

On the other hand, FIG. 7 shows an operating state of the hand-type muscular relief apparatus 100 in accordance with the present invention, in which the user attaches the muscular relief apparatus 100 onto his body part through a belt.

As shown in FIG. 7, a fixing member 120 with its adjustable length is connected to the coupling loops 114 of the lower case 113; the muscular relief member 140 is closely contacted to the abdomen of the body; and then the vibration is directly transmitted to the abdomen while the case 110 is fixed. Accordingly, it is also possible to have an effect of conventional belt exercise equipment.

Herein, the apparatus can be used while being fixed to the inner part of the thigh and the like as the length of the fixing member 120 can be adjusted.

In this manner, the user can easily contact the hand-type muscular relief apparatus 100 with any body part, and the hand-type muscular relief apparatus 100 can have the muscular relief effect from the vibration.

As described above, the hand-type muscular relief apparatus 100 of the present invention has a compact size such that the user can grip it with a hand, thereby allowing the muscular relief apparatus 100 to be used by easily being contacted with the forearm, the neck and vicinity thereof, the inner part of the thigh and the like. Further, the additional fixing member 120 can be installed in the muscular relief apparatus 100, thereby allowing the muscular relief apparatus 100 to be used while being fixed to a specific body part.

While the invention has been shown and described with respect to the embodiments, it will be understood by those skilled in the art that various changes and modification may be made without departing from the scope of the invention as defined in the following claims.

What is claimed is:

1. A muscular relief apparatus capable of relaxing muscle of a body part, comprising:
a case having a space formed therein and a gripping-part that is to be gripped by fingers of a user;
a muscular relief member to be in contact with the body part for making a vibration by a reciprocal movement;
a motor installed in the space of the case for generating rotational force; and
a transmission module for converting the rotational force into the reciprocal movement of the muscular relief member.

2. The muscular relief apparatus of claim 1, further comprising:
a guide rail provided in the case;
a moving member connected by the transmission module to apply a linear reciprocal movement along the guide rail; and
a plurality of supporting parts installed on the bottom surface of the moving member to support the muscular relief member.

3. The muscular relief apparatus of claim 4, wherein the muscular relief member includes an acupressure plate attached to the muscular relief member, the acupressure plate having a plurality of acupressure protrusions.

4. The muscular relief apparatus of claim 4, wherein the transmission module includes:
a first reduction pulley linked with the motor;
a rotation pulley linked with a second reduction pulley;
a cam shaft connected to the rotation pulley; and
a connecting rod, where in one end of the connecting rod is connected to a cam of the cam shaft and the other end of the connecting rod is connected to the moving member.

5. The muscular relief apparatus of claim 1, wherein the case has coupling loops formed at both ends of the case, and a fixing member that fixes the case to the body is connected with the coupling loops.

6. The muscular relief apparatus of claim 1, wherein the case has a ventilation part cut in a slit shape to dissipate heat generated within the case.

7. The muscular relief apparatus of claim 1, wherein a fan is further installed along a circumference direction in one side of the rotation pulley to dissipate heat generated within the case.

8. The muscular relief apparatus of claim 1, further comprising:
a manipulation panel for controlling the motor; and
a wireless receiver installed in the case and electrically connected to the manipulation panel to receive a manipulation signal transmitted from an outside of the case.
